(19) United States
(12) Patent Application Publication
(10) Pub. No.: US 2025/0371527 A1
(43) Pub. Date: Dec. 4, 2025

(54) INTELLIGENT SYSTEM AND METHOD TO DERIVE A NORMALIZED CONSENT PROTOCOL FOR HETEROGENEOUS DISTRIBUTED LEDGER LEVERAGING NEURO-SYMBOLIC ARTIFICIAL INTELLIGENCE (AI)

(71) Applicant: Bank of America Corporation, Charlotte, NC (US)

(72) Inventors: Pushkar Teneja, Hyderabad Telangana (IN); Suryanarayana Adivi, Hyderabad Telangana (IN); Shailendra Singh, Maharashtra (IN); Jemlin Lucas, Addison, TX (US); Shilpa Sameer Sarang, Mumbai Maharashtra (IN); Satyanarayana Reddy Bojanapally, Hyderabad Telangana (IN); Sunilkumar Sriperambudur, Hyderabad Telangana (IN)

(21) Appl. No.: 18/679,803

(22) Filed: May 31, 2024

(51) Int. Cl. G06Q 20/38; G06F 21/10; G06Q 20/36

(52) U.S. Cl. CPC G06Q 20/382; G06F 21/108; G06Q 20/36; G06Q 20/389; G06Q 2220/00

(57) ABSTRACT

A system and method may generate a normalized protocol model that leverages heterogeneous distributed ledger technology and is interoperable across different blockchain networks that may initially use different network protocols. The model may be generated by leveraging neuro-symbolic artificial intelligence (AI). The model that is generated may be based on the different network protocols that are in use at the different blockchain networks. The model may be adopted by the blockchain networks upon the blockchain networks providing unified consent to its adoption. The model may be required to be implemented by each of the different blockchain networks. The consensus to adopt the model may be recorded in one or more smart contracts. Copies of the smart contracts may be stored at the blockchain networks. The normalized protocol model may allow electronic transaction, data exchanges, and communications to be performed across blockchain networks and recorded in a heterogeneous distributed ledger.

### FIELD OF THE DISCLOSURE

Aspects of the disclosure relate to leveraging neuro-symbolic artificial intelligence (AI) to derive a global normalized consent protocol model to enable heterogenous Distributed Ledger Technology (DLT) across multiple blockchain networks.

### BACKGROUND OF THE DISCLOSURE

Distributed Ledger Technology may be beneficially used to track transactions. However, it may be difficult to track transactions that are performed across heterogeneous (different) blockchain networks using DLT because the heterogeneous networks may operate on different platforms that use different protocols, including different policies, rules, and interfaces, and may maintain a separate set of data and applications. Accordingly, users may find it difficult and confusing to manage their accounts across the different platforms. Some users may therefore avoid using more than one blockchain network.

A customized protocol could be specifically developed and adapted to operate across given blockchain networks that use different network protocols, such as to allow for electronic transactions across the given blockchain networks. However, developing such a protocol may prove time consuming and may have to be manually changed by developers each time a blockchain networks updates its network protocols.

Interaction between different platforms may also pose other challenges. Safety risks may arise with new attack routes, making data and assets vulnerable. Data privacy may be hard to balance across platforms, and a privacy breach may shake user trust. Variations in consensus methods and data formats may make communication more difficult to implement, which may impact security. Connecting platforms may require skilled maintenance, which may add cost and resource consumption. Without set standards, integrating DLT systems may be complex, which may slow progress. Trust and governance need work to manage DLT networks effectively. Regulatory confusion adds risk in the absence of clear rules to support growth and safety. As a result, users may avoid using DLT across blockchain platforms, and may miss out on benefits of DLT.

It is desirable to provide interoperability across different blockchain networks by leveraging neuro-symbolic AI to derive a global normalized consent protocol model that may be used by the blockchain networks and over which electronic transactions, data exchanges, and communications, may be tracked using a heterogenous distributed ledger.

### SUMMARY OF THE DISCLOSURE

It is an object of this invention to provide a system and method to derive a global normalized consent protocol model, leveraging neuro-symbolic AI, to enable interoperability between different blockchain networks using a heterogeneous distributed ledger. Neuro-symbolic AI is a type of artificial intelligence that integrates neural and symbolic AI architectures.

A system in accordance with the present disclosure may be implemented using one or more non-transitory computer-readable medium storing computer-executable instructions, that, when executed on one or more processors on a computer system, perform a method for generating a normalized protocol model that leverages distributed ledger technology and is interoperable across a plurality of different blockchain networks. Each of the plurality of different blockchain networks may use different network protocols initially before a normalized network model is generated. The network protocols may include network protocols for communication abstraction layers in the Open Systems Interconnection (OSI) model.

The method may include selecting, by the one or more processors leveraging neuro-symbolic artificial intelligence (AI), a normalized network protocol for inclusion in the normalized protocol model. The selection of the normalized network protocol may be based on the different network protocols. The selection may be configured to enable electronic transactions to be performed, and data and communications to be exchanged between the plurality of different blockchain networks. The method may include requesting, by the one or more processors, electronic consent from the plurality of different blockchain networks to implement the normalized network protocol at the plurality of different blockchain networks. The receipt of the electronic consent from each of the plurality of different blockchain networks may indicate a consensus to implement the normalized protocol model. The method may include triggering implementation, by the one or more processors of the normalized protocol model to be used by transmitting electronic notifications, by the one or more processors, to each of the plurality of different blockchain networks. The method may include enforcing the implementation of the normalized protocol model at the different blockchain networks.

The implementation of the normalized protocol model at the plurality of different blockchain networks may facilitate seamless electronic transactions, data exchanges, and communications across the plurality of different blockchain networks. The method may include recording data related to the electronic transactions, data exchanges, and communications in a heterogeneous distributed ledger that maintains records across the plurality of different blockchain networks.

The normalized network protocol may include one or more network protocols that may be implemented at the different blockchain networks. The one or more network protocols of the normalized network protocol may include network protocols for communication abstraction layers in the OSI model. The normalized network protocol may include one or more of a transport layer protocol, an application layer protocol, a routing protocol, an internet layer protocol, a network security protocol, a wireless protocol, a network management protocol, or a voice over IP protocol. Each of the plurality of different blockchain networks may include one or more virtual networks.

The one or more processors may be configured to convert between network protocols at the plurality of different blockchain networks. This may allow a blockchain network to generate the electronic transactions, data exchanges, and communications using one network protocol and convert it within the blockchain network to the normalized network protocol to be transmitted. The one or more processors may be configured to cause a change to one or more of the different network protocols that are in use at the plurality of different blockchain networks to conform to the normalized protocol model.

The method may include recording the electronic consent by the plurality of different blockchain networks in one or more smart contracts, and saving a copy of the one or more smart contracts at each of the plurality of different blockchain networks.

The method may include deriving, by the one or more processors, an electronic consent protocol for requesting the electronic consent from the plurality of different blockchain networks. The deriving of the electronic consent protocol may include determining, by the one or more processors, the different network protocols that are in use at the plurality of different blockchain networks before selecting the normalized network protocol. The deriving may include determining, by the one or more processors, the types of electronic transactions, data exchanges, and communications that may be conducted, such as based on a heterogeneous distributed ledger that may maintain records across the plurality of different blockchain networks. The deriving may include selecting, by the one or more processors, the electronic consent protocol to be used based on the different network protocols that are in use at the plurality of different blockchain networks and based on the heterogeneous distributed ledger. The electronic consent protocol may be compatible with the normalized network protocol and the electronic transactions, data exchanges, and communications that may be recorded in the heterogenous distributed ledger.

The method may include determining, by the one or more processors using neuro-symbolic AI, the different network protocols that are initially used at the plurality of different blockchain networks before the selection of the normalized network protocol. The neuro-symbolic AI may be configured to identify which of the different network protocols at the different blockchain networks correspond to one another and are to be normalized.

The method may include detecting, by the one or more processors, one or more changes to one or more of the different network protocols implemented at the plurality of different blockchain networks after implementation of the normalized protocol model. The method may include updating, by the one or more processors using the neuro-symbolic AI, the normalized protocol model to account for the one or more changes. The method may include requesting, by the one or more processor, an updated electronic consent from the plurality of different blockchain networks before implementing the updated normalized protocol model. This may maintain cross-network interoperability of the updated normalized protocol model in view of the one or more changes.

The implementation of the normalized protocol model at the plurality of different blockchain networks by the one or more processors may facilitate a transfer of assets between different digital wallets or payment systems.

The different network protocols implemented at the plurality of different blockchain networks may include security protocols, and the method may include normalizing the security protocols among the plurality of different blockchain networks.

The method may include securely tracking sales or transfers of goods or services executed across two or more of the plurality of different blockchain networks using the normalized protocol model.

The method may include securely exchanging patient data and medical records across the plurality of different blockchain networks using the normalized protocol model.

The method may include enabling resource sharing, by the one or more processors using the normalized protocol model, across the plurality of different blockchain networks to deploy one or more decentralized applications (DApps) by leveraging resources at two or more of the plurality of different blockchain networks.

The method may include auditing, by the one or more processors using the normalized protocol model, processes performed at the plurality of different blockchain networks to authenticate users of the plurality of different blockchain networks.

The method may include encrypting, by the one or more processors, electronic data transmitted between the plurality of different blockchain networks based on the normalized protocol model.

The normalized protocol model may be implemented on a cloud network that includes one or more network or Internet routers.

A system in accordance with the present disclosure may be implemented using one or more non-transitory computer-readable medium storing computer-executable instructions, that, when executed on one or more processors on a computer system, perform a method for generating a normalized protocol model that leverages distributed ledger technology and is interoperable across a plurality of different blockchain networks.

The method may include determining, by the one or more processors, the different network protocols that are in use at the plurality of different blockchain networks. The method may include selecting, by the one or more processors leveraging neuro-symbolic artificial intelligence (AI), a normalized protocol model based on the different network protocols that are in use at the plurality of different blockchain networks to enable electronic transactions to be performed between the plurality of different blockchain networks. The method may include requesting, by the one or more processors, electronic consent from the plurality of different blockchain networks to implement the normalized protocol model at the plurality of different blockchain networks. The method may include receiving, by the one or more processors, the electronic consent from each of the plurality of different blockchain networks that indicates a consensus to implement the normalized protocol model. The method may include, in response to receipt of the electronic consent from each of the plurality of different blockchain networks. The method may include triggering implementation, by the one or more processors of the normalized protocol model at the plurality of different blockchain networks by transmitting electronic notifications, by the one or more processors, to each of the plurality of different blockchain networks. The method may include enforcing the implementation of the normalized protocol model at the different blockchain networks.

The normalized protocol model may include a set of network protocols. The network protocols may include one or more of a transport layer protocol, an application layer protocol, a routing protocol, an internet layer protocol, a network security protocol, a wireless protocol, a network management protocol, or a voice over IP protocol. The network protocols may include network protocols for communication abstraction layers in the OSI model. The implementation of the normalized protocol model may facilitate recording data related to the electronic transactions, data exchanges, and communications in a heterogeneous distributed ledger that maintains records across the plurality of different blockchain networks.

The method may include recording the electronic consent by the plurality of different blockchain networks in one or more smart contracts, and saving a copy of the one or more smart contracts at each of the plurality of different blockchain networks.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system architecture in accordance with principles of the disclosure.

FIG. 2 shows an illustrative apparatus of a device in accordance with principles of the disclosure.

FIG. 3 shows an illustrative system architecture in accordance with principles of the disclosure.

FIG. 4 shows an illustrative global normalized consent protocol model in accordance with principles of the disclosure.

FIG. 5 shows an illustrative first blockchain network interacting with the global normalized consent protocol model that includes multiple network protocols in accordance with principles of the disclosure.

FIG. 6 shows an illustrative second blockchain network interacting with the global normalized consent protocol model that includes different multiple network protocols in accordance with principles of the disclosure.

FIG. 7 shows an illustrative list of different network protocols that may be implemented at blockchain networks in accordance with principles of the disclosure.

FIG. 8 shows an illustrative process flow for a normalized consent protocol model and unified consensus mechanism in accordance with principles of the disclosure.

FIG. 9 shows an illustrative example of a flow chart of a method for generating a normalized consent protocol and a unified consensus mechanism in accordance with principles of the disclosure.

FIG. 10 shows an illustrative system architecture for generating the normalized protocol model in accordance with principles of the disclosure.

### DETAILED DESCRIPTION OF THE DISCLOSURE

A system and method may be provided for a normalized multi-blockchain network protocol (a normalized network protocol) that uses a global normalized consent protocol model (normalized protocol model). The global normalized consent protocol model may serve as a universal intermediary between multiple blockchain networks that may use different network protocols from one another. The normalized multi-blockchain network protocol may evaluate and enforce network policies and rules across different blockchain networks by leveraging neuro-symbolic AI. Neuro-symbolic AI may derive new global normalized consent protocols by assessing a heterogeneous distributed ledger.

By acting as a common consent protocol bridge, the multi-blockchain network protocol may enable seamless transactions, data exchanges, and communication in a multi-blockchain environment. This Unified Consensus Mechanism authorized protocol streamlines interactions with multiple networking systems, ensuring interoperability between diverse blockchain platforms. Users may conduct transactions across different networks with enhanced efficiency, security, and convenience due to this standardized networking approach.

Cross-network interoperability in distributed ledger technology may present significant opportunities to revolutionize industries and use cases by facilitating seamless communication and collaboration between different blockchain networks that use different platforms. This interoperability may drive innovation, efficiency, and trust in the decentralized digital landscape, unlocking new avenues for growth and development. The standardized multi-blockchain network protocol may play a key role in enabling this transformation, providing a framework for different blockchain platforms to interact cohesively and effectively. By establishing common rules and standards, the protocol may enhance communication and cooperation between networks and may pave the way for increased interoperability and collaboration in the blockchain ecosystem. Thus, distributed ledger technology may enable seamless communication and collaboration between different blockchain networks and unlock new opportunities for innovation, efficiency, and trust in the decentralized digital ecosystem.

A normalized network protocol may also be configured to dynamically assess and adapt to various network policies and rules, leveraging neuro-symbolic AI, to ensure that transactions are executed efficiently and securely in the constantly evolving multi-blockchain environment. Neuro-symbolic AI may derive new global normalized consent protocols by assessing a heterogeneous distributed ledger.

The normalized network protocol may also be configured to perform scalable and efficient transaction processing, which may streamline and enhance the speed and scalability of blockchain transactions.

The normalized consent protocol may be used with the normalized network protocol. The normalized consent protocol may incorporate a unified consensus mechanism that harmonizes different consensus algorithms used by various blockchain networks. The harmonization may ensure a coherent decision-making process for transaction validation and network governance.

The normalized network protocol may introduce a mechanism for efficient resource sharing across multiple blockchain networks, enabling seamless access to assets and data stored on different chains without compromising security or privacy.

The normalized network protocol may bolster the security of transactions and data exchanges and safeguard sensitive information from malicious actors enhanced security and privacy features across multiple blockchain networks by integrating advanced encryption and privacy protocols. The encryption may include encryption of electronic data transmitted between the different blockchain networks based on the normalized protocol model.

The normalized network protocol may offer comprehensive real-time monitoring and auditing capabilities, allowing network administrators to track transaction activities in real-time and conduct thorough audits to ensure compliance with regulatory requirements.

The normalized network protocol may ensure compatibility with smart contracts deployed on various blockchain networks, enabling the seamless execution of complex contractual agreements and automated processes across different platforms. If protocols, policies, or rules are updated at one of the blockchain networks, the multi-blockchain network may arrange to update and reconcile the update among the connected blockchain networks. Updates may be agreed to with updated smart contracts.

Each blockchain network may use a different set of protocols. A multi-blockchain network protocol may use a global normalized consent protocol model intermediate the different blockchain networks to normalize, for standardization, which protocols are used in the multi-blockchain network. The normalization may be established by agreement between the operators of the blockchain networks and may require compromises between different protocols, policies, or rules of the blockchain networks. The model may establish a normalization layer that operates to normalize the protocols, including policies and rules, jointly between blockchain networks. The multi-blockchain network may establish smart contracts between the blockchain networks to reflect the agreed protocols, including policies and rules. Copies of the smart contracts may be stored at each of the blockchain networks.

For example, where one blockchain network platform may require one level of security while another platform requires a comparatively higher level of security, the multi-blockchain network protocol may normalize security requirements by requiring agreement by both blockchain networks to require the higher level of security.

The normalization may require data collection of the mechanisms in use at the blockchain networks, analysis of the collected data, establishing of normalized protocols, policies, and rules, and policy enforcement. While normalization may be used to enable performance of transactions across the blockchain networks, the protocols, policies, and rules may remain unchanged for transactions only performed within a particular blockchain network.

The above normalized protocols may operate in conjunction with a Network Consent Protocol. An example of a Network Consent Protocol configuration that is compatible with multiple blockchain networks is the Interledger Protocol (ILP). ILP may be configured to facilitate payments across different payment networks, including both traditional financial systems and blockchain networks. ILP may function as a protocol suite that enables interoperability between disparate networks by establishing a common protocol for routing payments.

For example, where a user wants to transfer funds from a Bitcoin wallet to an Ethereum wallet, by implementing the ILP protocol, the user may seamlessly initiate a payment transaction that will be routed through the Bitcoin network, converted into a standardized format, and then transferred to the Ethereum network for final settlement. The ILP protocol serves as the intermediary that harmonizes the transaction process between these two blockchain networks, ensuring smooth and efficient cross-network transactions.

In this way, a Network Consent Protocol configuration may be leveraged, using the ILP protocol, to enable interoperability and facilitate transactions across multiple blockchain networks.

Cross-network interoperability of different blockchain networks to communicate and exchange data with each other seamlessly may improve efficiency, reduce redundancy, and open up new possibilities for innovation.

Illustrative embodiments of methods, systems, and apparatus in accordance with the principles of the invention will now be described with reference to the accompanying drawings, which form a part hereof. It is to be understood that other embodiments may be used, and structural, functional, and procedural modifications may be made without departing from the scope and spirit of the present invention.

The drawings show illustrative features of methods, systems, and apparatus in accordance with the principles of the invention. The features are illustrated in the context of selected embodiments. It will be understood that features shown in connection with one of the embodiments may be practiced in accordance with the principles of the invention along with features shown in connection with another of the embodiments.

The methods, apparatus, computer program products, and systems described herein are illustrative and may involve some or all the steps of the illustrative methods and/or some or all of the features of the illustrative system or apparatus. The steps of the methods may be performed in an order other than the order shown or described herein. Some embodiments may omit steps shown or described in connection with the illustrative methods. Some embodiments may include steps that are not shown or described in connection with the illustrative methods, but rather are shown or described in a different portion of the specification.

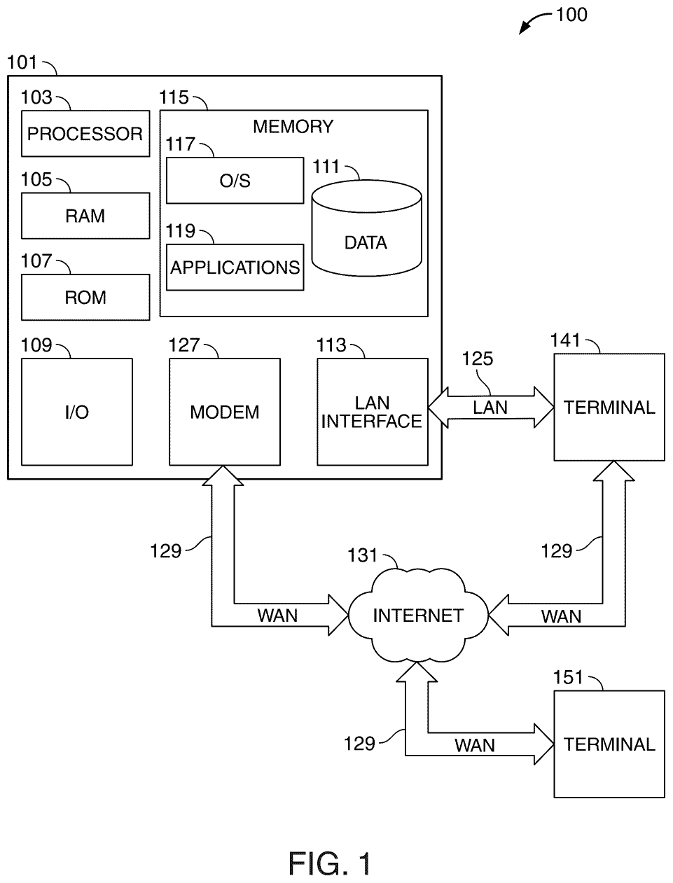

FIG. 1 shows an illustrative block diagram of system 100 that includes computer 101. Computer 101 may alternatively be referred to herein as an “engine,” “server” or a “computing device.” Computer 101 may be any computing device described herein, such as the computing devices running on a computer, smart phones, smart cars, smart cards, and any other mobile device described herein. Elements of system 100, including computer 101, may be used to implement various aspects of the systems and methods disclosed herein.

Computer 101 may have a processor 103 for controlling the operation of the device and its associated components, and may include RAM 105, ROM 107, input/output circuit 109, and a non-transitory or non-volatile memory 115. Machine-readable memory may be configured to store information in machine-readable data structures. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application(s) 119 along with any data 111 needed for the operation of computer 101. Memory 115 may also store videos, text, and/or audio assistance files. The data stored in Memory 115 may also be stored in cache memory, or any other suitable memory.

Input/output (“I/O”) module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

Computer 101 may be connected to other systems via a local area network (LAN) interface 113. Computer 101 may operate in a networked environment supporting connections to one or more remote computers, such as terminals 141 and 151. Terminals 141 and 151 may be personal computers or servers that include many or all the elements described above relative to computer 101.

In some embodiments, computer 101 and/or Terminals 141 and 151 may be any of mobile devices that may be in electronic communication with consumer device 106 via LAN, WAN, or any other suitable short-range communication when a network connection may not be established.

When used in a LAN networking environment, computer 101 is connected to LAN 125 through a LAN interface 113 or an adapter. When used in a WAN networking environment, computer 101 may include a communications device, such as modem 127 or other means, for establishing communications over WAN 129, such as Internet 131.

In some embodiments, computer 101 may be connected to one or more other systems via a short-range communication network (not shown). In these embodiments, computer 101 may communicate with one or more other terminals 141 and 151, such as the mobile devices described herein etc., using a personal area network (PAN) such as Bluetooth®, NFC (Near Field Communication), ZigBee, or any other suitable personal area network.

It will be appreciated that the network connections shown are illustrative and other means of establishing a communications link between computers may be used. The existence of various well-known protocols such as TCP/IP, Ethernet, NFT, HTTP, and the like is presumed, and the system can be operated in a client-server configuration to permit retrieval of data from a web-based server or API (Application Programming Interface). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application programs 119 may use one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may use the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

One or more of applications 119 may include one or more algorithms that may be used to implement features of the disclosure.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, Blackberry TM, tablet, smartphone, or any other computing system for receiving, storing, transmitting and/or displaying relevant information. Terminal 151 and/or terminal 141 may be one or more user devices. Terminals 151 and 141 may be identical to computer 101 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, and/or smartphones, multiprocessor systems, microprocessor-based systems, cloud-based systems, programmable consumer electronics, network PCs, minicomputers, mainframe computers, distributed computing environments that include any of the above systems or devices, and the like.

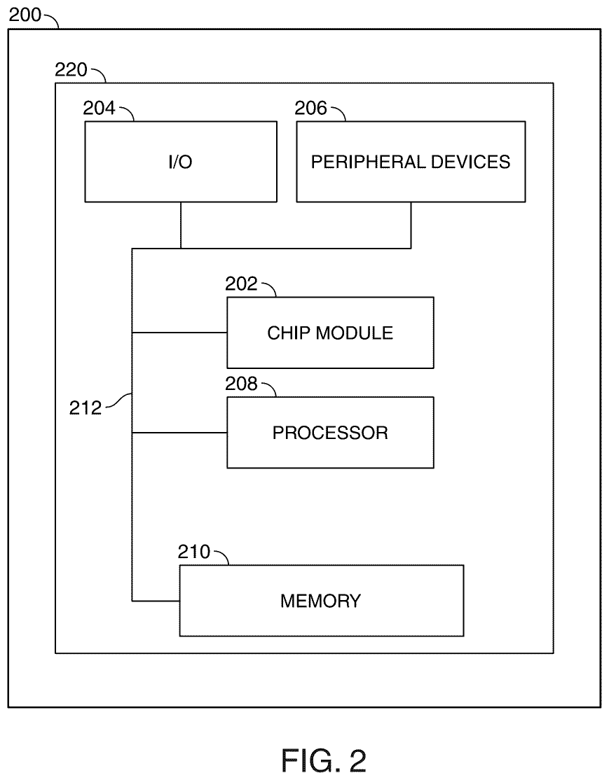

FIG. 2 shows illustrative apparatus 200, which may be a computing device. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY level hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

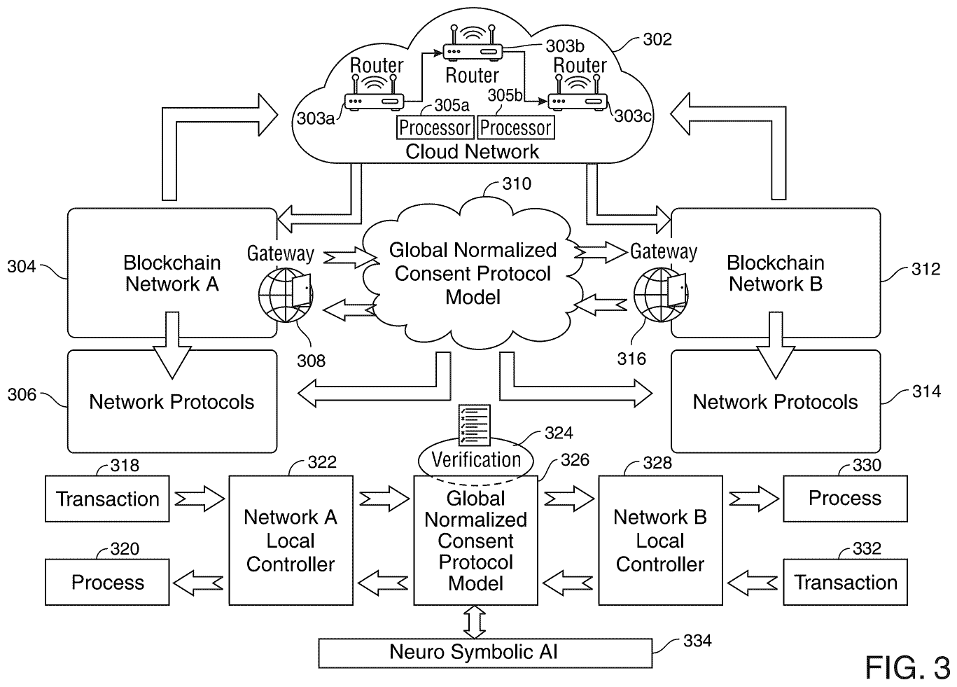

FIG. 3 shows an illustrative system architecture with which a normalized protocol model 310 may be generated and implemented in accordance with principles of the disclosure. The normalized protocol model 310 may include an electronic consent protocol that may be used to obtain electronic consent by the different blockchain networks to implement the normalized protocol model.

In this example, two blockchain networks, network A 304 and network B 312 are shown as examples of different blockchain networks that may implement different network protocols. For example, one set of network protocols 306 may be used at blockchain network 304, and a different set of network protocols 314 may be used at blockchain network 312.

Blockchain networks 304, 312 may be operated by different entities. Blockchain networks 304, 312 may be enabled for communication with one another, such as, for example, via a cloud network 302 or via one or more dedicated servers. The communications may be wired or wireless. Cloud network 302 may include one or more routers 303a, 303b, 303c, such as network or Internet routers, and one or more processors 305a, 305b. The normalized protocol model 310 may be implemented on cloud network 302 or may be implemented on separate hardware, such as one or more servers that are in communication with blockchain networks 304, 312. Blockchain networks 304, 312 may each have a respective network gateway 308, 316 to the Internet.

Interactions across blockchain networks 304, 312 may be facilitated by global normalized consent protocol model 310 that may be located intermediate between blockchain networks 304, 312. The interactions may be performed between protocol model 310 and the local controllers 322, 328 at each of networks A and B. Protocol model 310 may use neuro-symbolic AI 334 as shown. The interactions may include, for example, electronic transactions, data exchanges, and communications.

In the example of an interaction illustrated at the bottom of FIG. 3, a first transaction 318 may originate in blockchain network 304. Data for first transaction 318 may be transmitted through local controller 322 to normalized protocol model 326 (which corresponds to normalized protocol model 310 shown above). Normalized protocol model 326 may verify at 324, using one or more processors such as processors 305a, 305b, that the transaction conforms to normalized protocol model 326. Data for first transaction 318 may be permitted to pass through to blockchain network 312 for processing via local controller 328.

Similarly, a second transaction 332 may be initiated at blockchain network 312 for transmission to blockchain network 304. Transaction 332 may be transmitted through local controller 328 to normalized protocol model 326 for verification and then to blockchain network 304 through local controller 322.

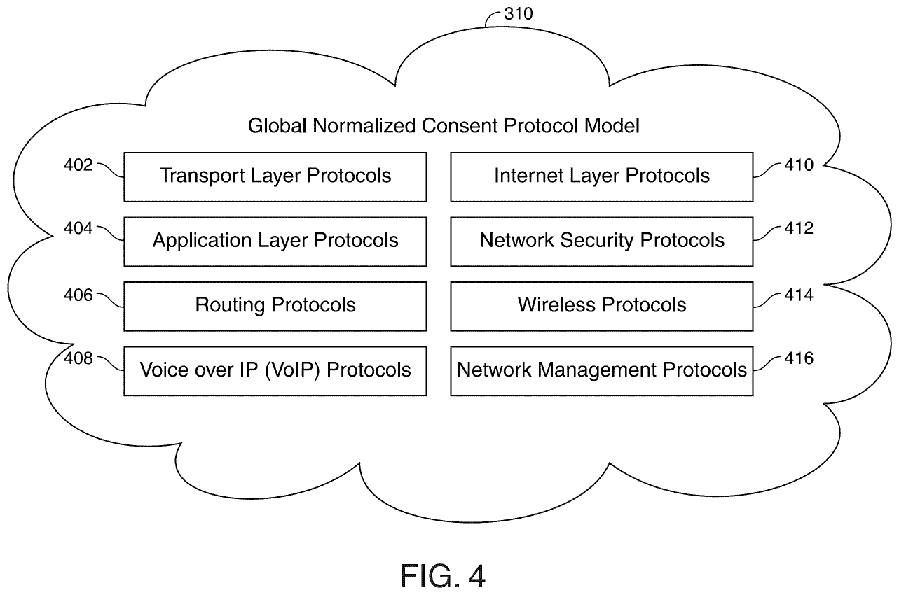

FIG. 4 shows illustrative features of global normalized consent protocol model 310. Protocol model 310 may include one or more network protocols, which may include one or more transport layer protocols 402, one or more application layer protocols 404, one or more routing protocols 406, one or more voice over IP (VOIP) protocols 408, one or more internet layer protocols 410, one or more network security protocols 412, one or more wireless protocols 414, or one or more network management protocols 416. For each of these different types of protocols, only one of each type of protocol may be permitted for use by blockchain networks 304, 312. For example, only one transport layer protocol, selected from various available transport layer protocols, may be allowed by the model. Alternatively, protocol model 310 may include multiple transport layer protocols that may be used. For example, one blockchain network may be allowed to use a first transport layer protocol and a second blockchain network may be allowed to use a second transport layer protocol if the two protocols are compatible.

These protocols that are included in protocol model 310 may be selected for inclusion in the model based on network protocols already in use at the different blockchain networks 304, 312 between which electronic transactions, communications, or data may be exchanged using protocol model 310. Protocol model 310 may also derive which network protocols to include in protocol model 310 based on an analysis of one or more distributed ledgers used by the different blockchain networks 304, 312. The electronic transactions, data exchanges, and communications that are performed by the different blockchain networks 304, 312 may be recorded in the heterogenous distributed ledger.

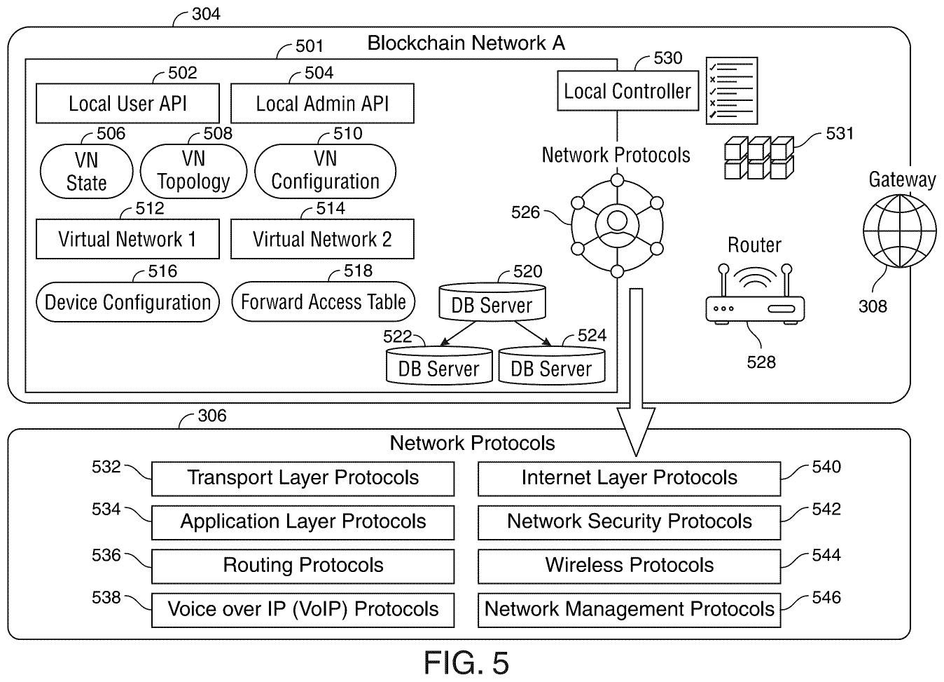

FIG. 5 shows an illustrative system architecture for blockchain network A 304. Blockchain network 304 may include, for example, a local user application programming interface (API) 502 that may be configured to interface with local infrastructure 501 for blockchain network 304. Infrastructure 501 may include a user computer, a local administrative API 504 that may be configured to interface with a network administrator's computer, one or more virtual networks (VN), such as a virtual network 1 512 and a virtual network 2 514, and a memory to store information related to a VN state 506, a VN topology 508, and a VN configuration 510. Blockchain network 304 may further include a device configuration file 516 for one or more devices in the virtual networks to maintain information about devices in the blockchain network 304, and a forward access table to forward data for storage at a database server, such as database servers 520, 522, 524. Blockchain network 304 may use network protocols 526. Network protocols 526 may include, for example, one or more transport layer protocols 532, one or more application layer protocols 534, one or more routing protocols 536, one or more voice over IP (VOIP) protocols 538, one or more internet layer protocols 540, one or more network security protocols 542, one or more wireless protocols 544, and one or more network management protocols 546. Blockchain network 304 may be controlled by local controller/processor 530 (which may correspond to local controller 322), and may include databases 531, a router 528, and network gateway 308 to connect to global normalized consent protocol model 310.

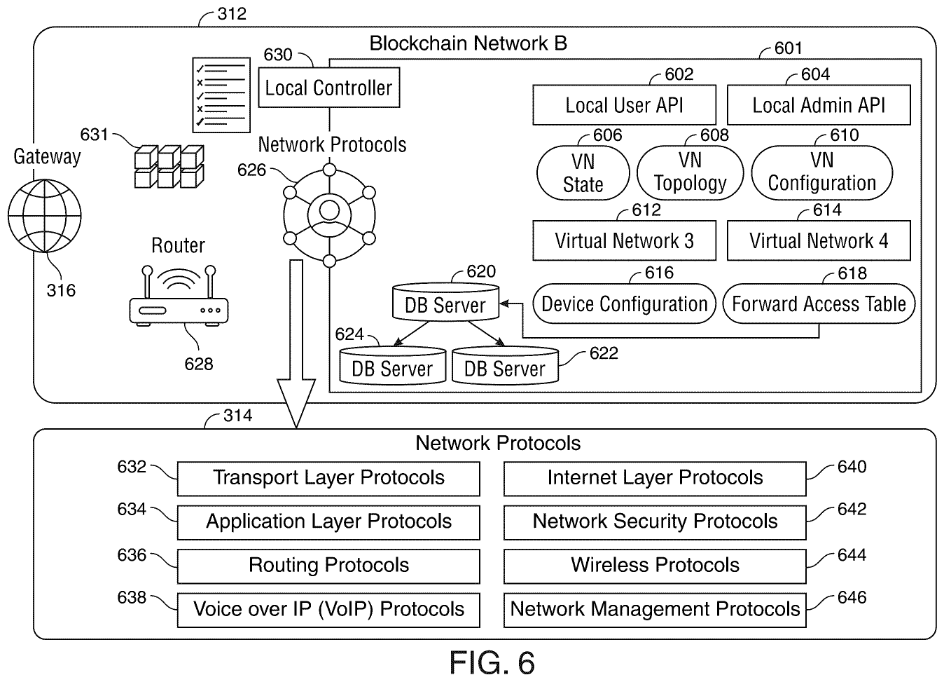

FIG. 6 shows an illustrative system architecture for blockchain network B 312. Blockchain network 312 may include, for example, a local user application programming interface (API) 602 that may be configured to interface with infrastructure 601 for blockchain network 312. Infrastructure 601 may include a user computer, a local administrative API 604 that may be configured to interface with a network administrator's computer, one or more virtual networks (VN), such as virtual network 3 612 and virtual network 4 614, and a memory to store information related to a VN state 606, a VN topology 608, and a VN configuration 610. Blockchain network 312 may further include a device configuration file 616 for one or more devices in the virtual networks to maintain information about devices in the blockchain network 312, and a forward access table to forward data for storage at a database server, such as database servers 620, 622, 624. Blockchain network 312 may use network protocols 626. Network protocols 626 may include, for example, one or more transport layer protocols 632, one or more application layer protocols 634, one or more routing protocols 636, one or more voice over IP (VOIP) protocols 638, one or more internet layer protocols 640, one or more network security protocols 642, one or more wireless protocols 644, and one or more network management protocols 646. Blockchain network 312 may be controlled by local controller/processor 630 (which may correspond to local controller 328), and may include databases 631, a router 628, and a gateway 316 to connect to global normalized consent protocol model 310.

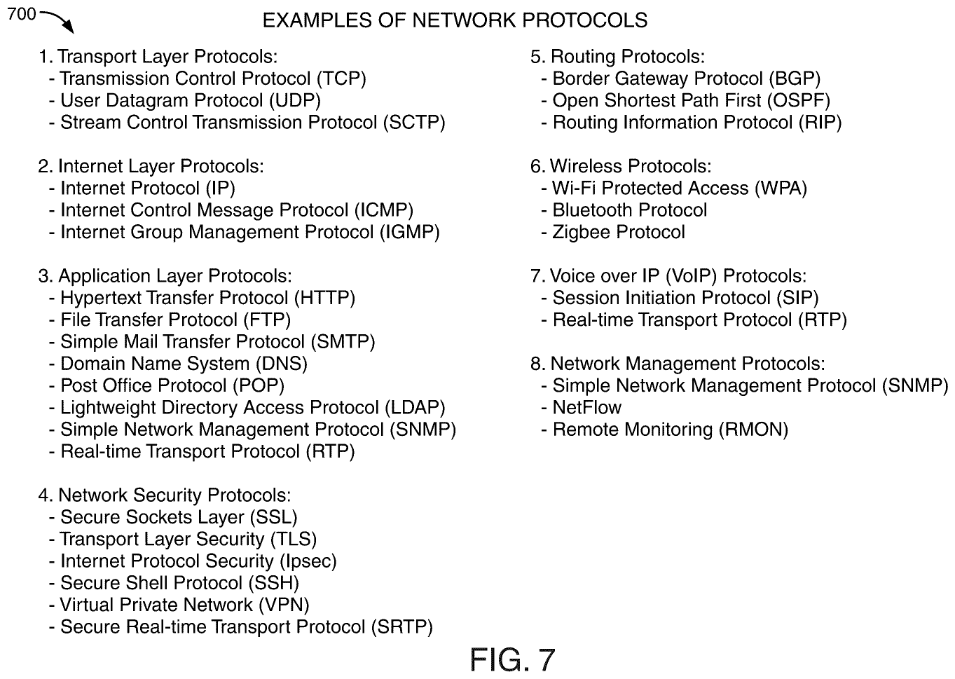

Illustrative examples of network protocols are shown in FIG. 7. For example, one blockchain network, such as blockchain network 304, may use one of multiple different transport layer protocols, one of multiple different internet layer protocols, one of multiple different application layer protocols, one of multiple network security protocols, one of multiple routing protocols, one of multiple wireless protocols, one of multiple VoIP protocols, and one of multiple network management protocols. A different blockchain network 312 may use a different set of protocols than blockchain network 304 such that the blockchain networks may not be interoperable without the use of an intermediate normalized protocol model 310.

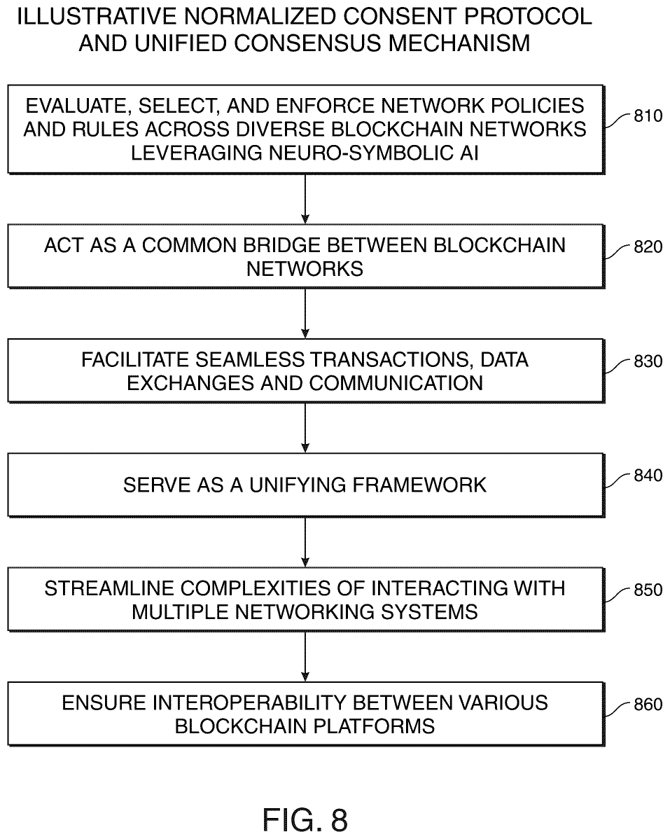

FIG. 8 shows an illustrative example of a process flow diagram for a normalized consent protocol and unified consensus mechanism. Implementing a global normalized consent protocol model enables blockchain networks that initially use incompatible network protocols to be interoperable for conducting electronic transactions, exchanging data, and communications. At 802, an illustrative normalized protocol model and a unified consent mechanism may evaluate and select which network protocols to use as part of a normalized protocol model to be implemented to allow electronic transactions, data exchange, and communications to be conducted across diverse blockchain networks. The unified consent mechanism may include obtaining electronic consent to the normalized protocol model from each of the blockchain networks. The normalized protocol model may then implement and enforce network policies and rules across the diverse blockchain networks leveraging neuro-symbolic AI. The network protocols in the model may be selected based on network protocols already in use at the diverse blockchain networks or based on the heterogeneous distributed ledger that may include records of transactions that have been performed using various network protocols. The normalized protocol model may be updated to reflect a change in the network protocols that are in use at one or more of the blockchain networks.

At 804, the normalized protocol model may act as a common bridge between the blockchain networks. Thus, at 806, the normalized protocol model may facilitate electronic transactions, data exchange, and communications to be conducted seamlessly across the blockchain networks. The normalized protocol model may also serve as a unifying framework (808), that may streamline complexities of interacting with multiple network systems (810) and may ensure interoperability between various blockchain platforms (812).

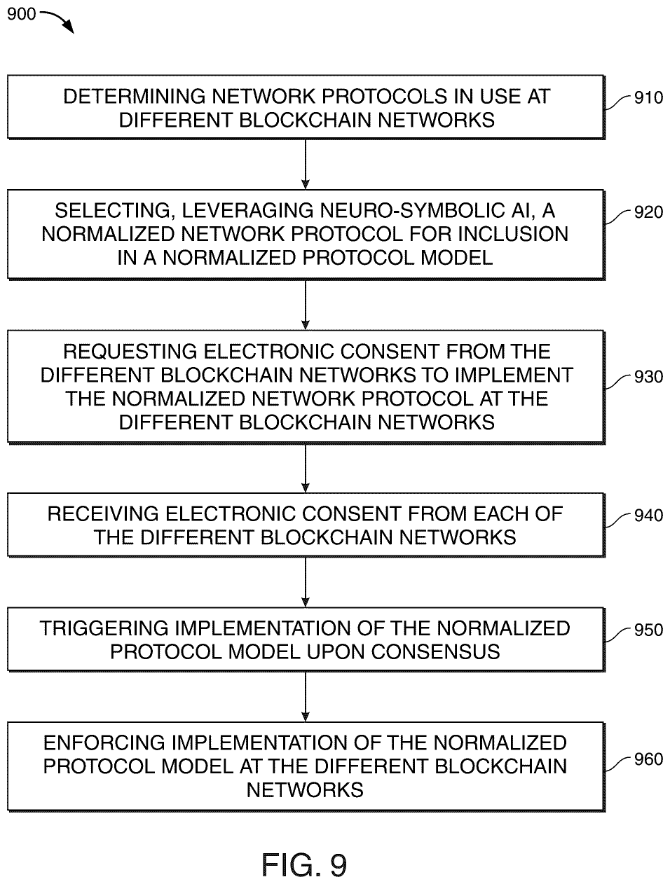

FIG. 9 shows an illustrative example of a flow chart 900 for performing a method for deriving a global normalized consent protocol model for a heterogeneous distributed ledger by leveraging neuro-symbolic AI. The method may be performed using one or more processors, such as may be located, for example, on a server or in a cloud. The model may be generated for use by blockchain networks that have agreed to use the model if the model that is proposed is acceptable.

At step 910, the one or more processors may determine the network protocols that are in use at the different blockchain networks. The different blockchain networks may be operated by different entities. The different blockchain networks may use one or more different network protocols. This information may be determined based on, for example, electronically requesting the information from the blockchain networks or derived based on, for example, a heterogenous distributed ledger that may be accessible to the one or more processors.

At step 920, the one or more processors may select a normalized network protocol for inclusion in a normalized protocol model. The normalized network protocol may include one or more network protocols. Each network protocol that may be selected for inclusion in the normalized network protocol may be the same as a network protocol that is in use at one or more of the different blockchain networks, a network protocol that may be most popularly used among the different blockchain networks, or may be a different network protocol that may not be in use at any of the blockchain networks. The neuro-symbolic AI may determine which network protocols at the different blockchain networks correspond to one another so that a network protocol that is selected for the normalized protocol model may be properly substituted, as needed, for an existing protocol at one of the blockchain networks that is not selected for use in the model.

At step 930, the one or more processors may request electronic consent from the different blockchain networks to implement the network protocol model, including the model's normalized network protocols. A unified electronic consent of all of the participating different blockchain networks may be required. The electronic consent may be recorded in one or more smart contracts. Copies of the smart contracts may be stored at each of the different blockchain networks.

At step 940, the one or more processors may receive the electronic consent from each of the different blockchain networks. At step 950, upon receiving the electronic consent from all of the blockchain networks, the one or more processors may trigger implementation of the normalized protocol model that has been adopted by consensus. The triggering may include transmitting by the one or more processors of an electronic notification to each of the blockchain networks that consensus has been achieved such that the blockchain networks update their network protocols. The update to the network protocols need not be performed immediately, but may be performed by some criteria established by the network protocol model, such as by a jointly agreed date and time.

At step 950, the model, using one or more processors, may enforce implementation of the normalized protocol model at the different blockchain networks. Various methods of enforcement may be utilized. For example, noncompliance with the normalized protocol model may result in not being able to participate with the other participating blockchain networks to conduct electronic transactions, data exchanges, and communications.

The global normalized consent protocol model may include an electronic consent protocol that may be derived for requesting and obtaining electronic consent to the normalized protocol model from the different blockchain networks. The derivation of the electronic consent protocol may include determining the different protocols that are in use at the different blockchain networks before the global normalized network protocol is selected. The derivation may include determining the types of electronic transactions, data exchanges, and communication based on the heterogeneous distributed ledger. The derivation may include selecting the electronic consent protocol to be used based on the different network protocols that are in use at the different blockchain networks. The selection of the electronic consent protocol may also be based on the heterogeneous distributed ledger such that the electronic consent protocol is compatible with network layer protocols and the electronic transactions, data exchanges, and communications that are recorded in the heterogeneous distributed ledger.

Changes may be made to one or more of the network protocols at the different blockchain networks from time to time. Changes may need to be detected so that the normalized protocol model may be updated to reflect a change in the network protocols that are in use at one or more of the blockchain networks. The updates to the model may use the neuro-symbolic AI. As part of the unified consensus mechanism, proposed changes to the normalized protocol model to reflect a change in the network protocols at one or more of the blockchain networks may require requesting an updated electronic consent to the change from each of the different blockchain networks. The requirement for an updated electronic consent may ensure that the cross-network inoperability of the different blockchain networks may be maintained.

The rules established by the multi-blockchain network as part of the normalized network protocol may be reviewed and overridden by a human network monitor.

The following are five examples of how cross-network interoperability can benefit different industries and applications. The operations that are performed in these examples may be recorded on a heterogeneous distributed ledger:
1. Finance and Payments: By enabling interoperability between different blockchain networks, users may easily transfer and exchange assets between different digital wallets and payment systems. This may streamline cross-border transactions, reduce fees, and increase the speed of settlements, which may benefit both individuals and businesses.
2. Supply Chain Management: Cross-network interoperability provided by the normalized protocol model may facilitate the transparent and secure tracking of goods and products across multiple different blockchain networks. This may help improve traceability, reduce fraud and counterfeiting, and enhance overall supply chain efficiency.
3. Healthcare Data Exchange: Healthcare providers may securely exchange patient data and medical records across different blockchain networks compliant with the normalized protocol model, ensuring data integrity and patient privacy. This may lead to improved care coordination, more accurate diagnoses, and better patient outcomes.
4. Decentralized Applications (DApps): Cross-network interoperability between different blockchain platforms that is provided by the normalized protocol model may allow developers to create DApps that leverage the strengths of multiple blockchain networks, such as by enabling resource sharing across the blockchain networks. For example, a gaming DApp may integrate assets from different blockchains, providing a richer and more engaging user experience.
5. Identity Management: Cross-network interoperability may enable seamless identity verification and authentication processes across different blockchain networks and may enable auditing of the verification and verification processes. This may enhance security, privacy, and streamline identity management processes for various applications such as voting systems, access control, and government services.

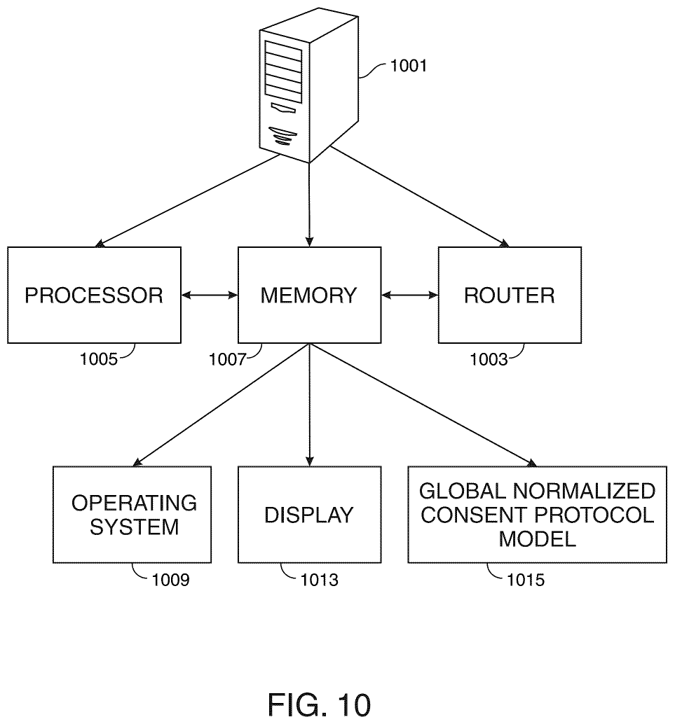

FIG. 10 shows an illustrative system architecture for generating the normalized protocol model in accordance with principles of the disclosure. The system architecture may be implemented on a cloud or on the Internet. A server 1001 may include a router 1003, a processor 1005, and a memory 1007. Memory 1007 may include an operating system 1009, a display 1013, and the normalized protocol model that is generated by processor 1005.

Overall, cross-network interoperability may unlock the full potential of blockchain technology and enabling seamless communication and data exchange across diverse networks and use cases.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for generating a normalized protocol model that leverages distributed ledger technology and is interoperable across a plurality of different blockchain networks may be provided. Persons skilled in the art will appreciate that the present invention can be practiced by other than the described embodiments, which are presented for purposes of illustration rather than of limitation.

What is claimed is:

1. One or more non-transitory computer-readable medium storing computer-executable instructions, which, when executed on one or more processors on a computer system, perform a method for generating a normalized protocol model that leverages distributed ledger technology and is interoperable across a plurality of different blockchain networks, each of the plurality of different blockchain networks using different network protocols, the method comprising:
selecting, by the one or more processors leveraging neuro-symbolic artificial intelligence (AI), a normalized network protocol for inclusion in the normalized protocol model, the selecting being based on the different network protocols, the selecting being configured to enable electronic transactions to be performed, and data and communications to be exchanged between the plurality of different blockchain networks;
requesting, by the one or more processors, electronic consent from the plurality of different blockchain networks to implement the normalized network protocol at the plurality of different blockchain networks;
in response to receipt of the electronic consent from each of the plurality of different blockchain networks that indicates a consensus to implement the normalized protocol model, triggering implementation, by the one or more processors of the normalized protocol model to be used by transmitting electronic notifications, by the one or more processors, to each of the plurality of different blockchain networks; and
enforcing the implementation of the normalized protocol model at the different blockchain networks.

2. The computer-readable medium of claim 1, wherein the implementation of the normalized protocol model at the plurality of different blockchain networks facilitates seamless electronic transactions, data exchanges, and communications across the plurality of different blockchain networks.

3. The computer-readable medium of claim 2, wherein the method further comprises:
recording data related to the electronic transactions, data exchanges, and communications in a heterogeneous distributed ledger that maintains records across the plurality of different blockchain networks.

4. The computer-readable medium of claim 1, wherein the one or more processors are configured to convert between network protocols at the plurality of different blockchain networks.

5. The computer-readable medium of claim 1, wherein the one or more processors are configured to cause a change to one or more of the different network protocols in use at the plurality of different blockchain networks to conform to the normalized protocol model.

6. The computer-readable medium of claim 1, wherein the implementation of the normalized protocol model at the plurality of different blockchain networks by the one or more processors facilitates transferring of assets between different digital wallets or payment systems.

7. The computer-readable medium of claim 1, wherein the method further comprises:
recording the electronic consent by the plurality of different blockchain networks in one or more smart contracts; and
saving a copy of the one or more smart contracts at each of the plurality of different blockchain networks.

8. The computer-readable medium of claim 1, wherein the method further comprises:
deriving, by the one or more processors, an electronic consent protocol for requesting the electronic consent from the plurality of different blockchain networks.

9. The computer-readable medium of claim 8, wherein the deriving of the electronic consent protocol comprises:
determining, by the one or more processors, the different network protocols that are in use at the plurality of different blockchain networks before selecting the normalized network protocol;
determining, by the one or more processors, the types of electronic transactions, data exchanges, and communications based on a heterogeneous distributed ledger that maintains records across the plurality of different blockchain networks; and
selecting, by the one or more processors, the electronic consent protocol to be used based on the different network protocols that are in use at the plurality of different blockchain networks and based on the heterogeneous distributed ledger such that the electronic consent protocol is compatible with the normalized network protocol and the electronic transactions, data exchanges, and communications that are recorded in the heterogenous distributed ledger.

10. The computer-readable medium of claim 1, wherein the method further comprises:
determining, by the one or more processors using neuro-symbolic AI, the different network protocols that are initially used at the plurality of different blockchain networks before the selection of the normalized network protocol;
wherein the neuro-symbolic AI is configured to identify which of the different network protocols at the different blockchain networks correspond to one another and are to be normalized.

11. The computer-readable medium of claim 1, wherein the method further comprises:
detecting, by the one or more processors, one or more changes to one or more of the different network protocols implemented at the plurality of different blockchain networks after implementation of the normalized protocol model;
updating, by the one or more processors using the neuro-symbolic AI, the normalized protocol model to account for the one or more changes; and
requesting, by the one or more processors, an updated electronic consent from the plurality of different blockchain networks before implementing the updated normalized protocol model.

12. The computer-readable medium of claim 1, wherein the normalized network protocol includes one or more of a transport layer protocol, an application layer protocol, a routing protocol, an internet layer protocol, a network security protocol, a wireless protocol, a network management protocol, or a voice over IP protocol.

13. The computer-readable medium of claim 1, wherein:
the different network protocols implemented at the plurality of different blockchain networks comprise security protocols; and
the method includes normalizing the security protocols among the plurality of different blockchain networks.

14. The computer-readable medium of claim 1, wherein the method further comprises securely tracking sales or transfers of goods or services executed across two or more of the plurality of different blockchain networks using the normalized protocol model.

15. The computer-readable medium of claim 1, wherein the method further comprises securely exchanging patient data and medical records across the plurality of different blockchain networks using the normalized protocol model.

16. The computer-readable medium of claim 1, wherein the method further comprises enabling resource sharing, by the one or more processors using the normalized protocol model, across the plurality of different blockchain networks to deploy one or more decentralized applications (DApps) by leveraging resources at two or more of the plurality of different blockchain networks.

17. The computer-readable medium of claim 1, wherein the method further comprises auditing, by the one or more processors using the normalized protocol model, processes performed at the plurality of different blockchain networks to authenticate users of the plurality of different blockchain networks.

18. The computer-readable medium of claim 1, wherein the method further comprises encrypting, by the one or more processors, electronic data transmitted between the plurality of different blockchain networks based on the normalized protocol model.

19. The computer-readable medium of claim 1, wherein the normalized protocol model is implemented on a cloud network comprising one or more network or Internet routers.

20. The computer-readable medium of claim 1, wherein each of the plurality of different blockchain networks comprises one or more virtual networks.

21. One or more non-transitory computer-readable medium storing computer-executable instructions, which, when executed on one or more processors on a computer system, perform a method for generating a normalized protocol model that leverages heterogeneous distributed ledger technology and is interoperable across a plurality of different blockchain networks that use different network protocols, the method comprising:
determining, by the one or more processors, the different network protocols that are in use at the plurality of different blockchain networks;
selecting, by the one or more processors leveraging neuro-symbolic artificial intelligence (AI), a normalized protocol model based on the different network protocols that are in use at the plurality of different blockchain networks to enable electronic transactions to be performed between the plurality of different blockchain networks;
requesting, by the one or more processors, electronic consent from the plurality of different blockchain networks to implement the normalized protocol model at the plurality of different blockchain networks;
receiving, by the one or more processors, the electronic consent from each of the plurality of different blockchain networks that indicates a consensus to implement the normalized protocol model; and
in response to receipt of the electronic consent from each of the plurality of different blockchain networks, triggering implementation, by the one or more processors of the normalized protocol model at the plurality of different blockchain networks by transmitting electronic notifications, by the one or more processors, to each of the plurality of different blockchain networks; and
enforcing the implementation of the normalized protocol model at the different blockchain networks;
wherein the normalized protocol model comprises a set of network protocols, including one or more of a transport layer protocol, an application layer protocol, a routing protocol, an internet layer protocol, a network security protocol, a wireless protocol, a network management protocol, or a voice over IP protocol.

22. The computer-readable medium of claim 21, wherein the implementation of the normalized protocol model facilitates recording data related to the electronic transactions, data exchanges, and communications in a heterogeneous distributed ledger that maintains records across the plurality of different blockchain networks.
